(19) United States
(12) Patent Application Publication
(10) Pub. No.: US 2013/0107242 A1
(43) Pub. Date: May 2, 2013

(54) MEASUREMENT APPARATUS

(71) Applicant: CANON KABUSHIKI KAISHA, Tokyo (JP)

(72) Inventor: Yuya Nishikawa, Utsunomiya-shi (JP)

(73) Assignee: CANON KABUSHIKI KAISHA, Tokyo (JP)

(21) Appl. No.: 13/657,153

(22) Filed: Oct. 22, 2012

(30) Foreign Application Priority Data
Nov. 1, 2011 (JP) 2011-240660

(51) Int. Cl. G01C 3/08

(52) U.S. Cl. 356/4.09

(57) ABSTRACT

The present invention provides a measurement apparatus which measures a distance between a reference surface and a test surface, including n (n=an integer of not smaller than 2) frequency scanning light sources, a splitting element configured to split beam from each of the n frequency scanning light sources to enter the reference surface and the test surface, a detector configured to detect n interference beams at once, formed by interference of beam reflected by the reference surface and beam reflected by the test surface, and output an interference signal, and a processing unit configured to perform processing of obtaining the distance.

### BACKGROUND OF THE INVENTION

1. Field of the Invention

The present invention relates to a measurement apparatus which measures the distance between a reference surface and a test surface.

2. Description of the Related Art

A frequency (wavelength) scanning interferometer and fixed-wavelength interferometer are known as measurement apparatuses which measure the distance between a reference surface and a test surface (object surface). The frequency scanning interferometer obtains the distance between a reference surface and a test surface, based on the frequency of an interference signal obtained by temporally scanning the frequency of a light source. The frequency scanning interferometer is advantageously simpler in arrangement and lower in cost than the fixed-wavelength light wave interferometer typified by a heterodyne interferometer or homodyne interferometer.

The frequency scanning interferometer requires a measurement condition that the optical path length difference between reference beam (beam reflected by the reference surface) and object beam (beam reflected by the test surface) does not change while scanning the frequency. Even a small change of the optical path length difference leads to a large measurement error. For example, when the center wavelength of the light source is 780 nm, the scanning amount of the frequency of the light source is 100 GHz (0.2 nm), and the optical path length difference changes by 1 nm while scanning the frequency, a measurement error of about 3.8 μm is generated. The optical path length difference inevitably changes owing to vibrations, temperature change, and the like. To prevent this, techniques for reducing a measurement error arising from a change of the optical path length difference between reference beam and object beam are proposed in Japanese Patent Laid-Open No. 7-120211, and “Hai-Jun Yang and Keith Riles, High-precision absolute distance measurement using dual-laser frequency scanned interferometry under realistic conditions, Nuclear Instruments & Methods in Physics Research, Section A, Volume 575, Issue 3, 1 Jun. 2007, pages 395-401 (literature 1)”.

Japanese Patent Laid-Open No. 7-120211 discloses a technique in which calculation processing is performed based on the phase difference between the beat signals of interference signals using two light sources (frequency scanning light sources) different in center wavelength, thereby reducing a measurement error arising from a change of the optical path length difference between reference beam and object beam. Literature 1 discloses a technique in which the average value of measurement values obtained from two interference signals is calculated using two frequency scanning light sources different in direction in which the frequency is scanned, thereby reducing a measurement error arising from a change of the optical path length difference between reference beam and object beam.

However, the technique in Japanese Patent Laid-Open No. 7-120211 requires two detectors to detect the interference signals of the two light sources, thereby increasing the apparatus cost. In particular, when measuring the shape of an object, a two-dimensional sensor such as a CCD or CMOS is used as the detector, greatly increasing the apparatus cost.

In the technique in literature 1, one detector detects the interference signals of the two light sources. For this purpose, this technique requires a chopper for temporally switching an interference signal to be detected by the detector, increasing the apparatus cost.

### SUMMARY OF THE INVENTION

The present invention provides a technique which reduces a measurement error arising from a change of the optical path length difference between a reference surface and a test surface while suppressing an increase in cost, and is advantageous to measurement of the distance between the reference surface and the test surface.

According to one aspect of the present invention, there is provided a measurement apparatus which measures a distance between a reference surface and a test surface, including n (n=an integer of not smaller than 2) frequency scanning light sources, a splitting element configured to split beam from each of the n frequency scanning light sources to enter the reference surface and the test surface, a detector configured to detect n interference beams at once, formed by interference of beam reflected by the reference surface and beam reflected by the test surface, and output an interference signal, and a processing unit configured to perform processing of obtaining the distance, wherein the processing unit controls to scan a frequency of light from a first light source out of the n frequency scanning light sources in a first direction at a first scanning speed, and controls to scan a frequency of light from a second light source different from the first light source, out of the n frequency scanning light sources, in a second direction opposite to the first direction at a second scanning speed different from the first scanning speed, and the processing unit obtains the distance by separating the interference signal including detection results of the n interference beams, output from the detector, into n signals corresponding to the n interference signals and processing the n signals while controlling the n frequency scanning light sources.

Further aspects of the present invention will become apparent from the following description of exemplary embodiments with reference to the attached drawings.

### BRIEF DESCRIPTION OF THE DRAWINGS

FIG. 1 is a view showing the arrangement of a measurement apparatus in the first embodiment of the present invention.

FIG. 2 is a view exemplifying an interference signal obtained by the detector of the measurement apparatus shown in FIG. 1.

FIG. 3 is a graph exemplifying the result of frequency analysis of the interference signal shown in FIG. 2.

FIG. 4 is a flowchart for explaining processing of measuring the distance between a reference surface and a test surface in the measurement apparatus shown in FIG. 1.

FIG. 5 is a view showing the arrangement of a measurement apparatus in the second embodiment of the present invention.

FIG. 6 is a flowchart for explaining processing of measuring the distance between a reference surface and a test surface in the measurement apparatus shown in FIG. 5.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

### First Embodiment

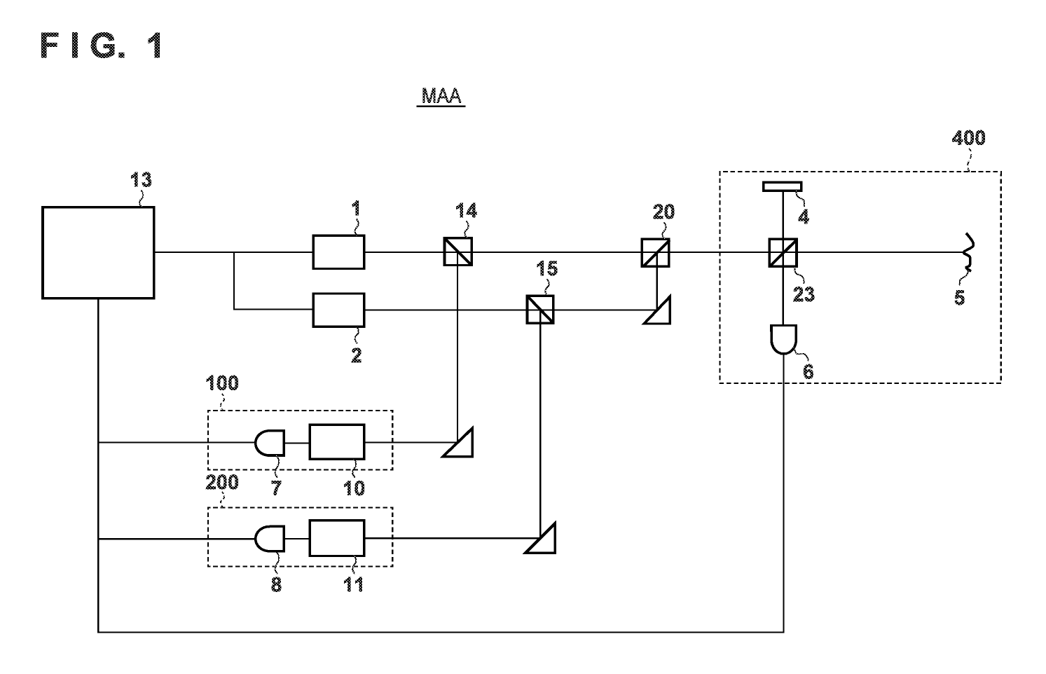

FIG. 1 is a view showing the arrangement of a measurement apparatus MAA in the first embodiment of the present invention. The measurement apparatus MAA is an interferometer which measures the distance between a reference surface and a test surface. The measurement apparatus MAA includes a first light source 1, a second light source 2, a processing unit 13, non-polarization beam splitters 14, 15, and 20, wavelength measurement units 100 and 200, and an interferometer unit 400. The wavelength measurement unit 100 includes a Fabry-Perot etalon 10 and detector 7. The wavelength measurement unit 200 includes a Fabry-Perot etalon 11 and detector 8. The interferometer unit 400 includes a non-polarization beam splitter 23 and detector 6.

In the embodiment, the measurement apparatus MAA includes two light sources (first light source 1 and second light source 2) capable of scanning the frequency of emitted light, but is not limited to this. For example, the measurement apparatus MAA may include three or more light sources capable of scanning the frequency of emitted light.

Beam L1 emitted by the first light source 1 is split into two by the non-polarization beam splitter 14. One beam is guided to the wavelength measurement unit 100, and the other beam is guided to the interferometer unit 400. Beam L2 emitted by the second light source 2 is split into two by the non-polarization beam splitter 15. One beam is guided to the wavelength measurement unit 200, and the other beam is guided to the interferometer unit 400.

The beam L1 entering the wavelength measurement unit 100 passes through the Fabry-Perot etalon 10 serving as a wavelength reference element, and enters the detector 7. The processing unit 13 controls the frequency (wavelength) of light emitted by the first light source 1 based on a light intensity (intensity of the beam L1) detected by the detector 7. Similarly, the beam L2 entering the wavelength measurement unit 200 passes through the Fabry-Perot etalon 11 serving as a wavelength reference element, and enters the detector 8. The processing unit 13 controls the frequency (wavelength) of light emitted by the second light source 2 based on a light intensity (intensity of the beam L2) detected by the detector 8.

As for the transmission spectra of the Fabry-Perot etalons 10 and 11, the relative values of the peaks of the respective transmission spectra need to be ensured. Thus, the embodiment adopts, as the Fabry-Perot etalons 10 and 11, vacuum gap etalons with an ensured transmission spectrum interval. The vacuum gap etalon can easily ensure the relative value of a wavelength because it has neither the refractive index nor dispersion of the internal medium. When the etalon is made of a low thermal expansion glass or the like, expansion with respect to the temperature can be reduced, implementing a wavelength reference element which is stable for a long period of time. However, the Fabry-Perot etalons 10 and 11 are not limited to the vacuum gap etalons, and may be air gap etalons or solid etalons. In this case, the internal refractive index and dispersion need to be ensured by, for example, measuring the temperature of the etalon. Each of the Fabry-Perot etalons 10 and 11 has at least two transmission spectra within the scanning range of the frequency of light from each of the first light source 1 and second light source 2. Accordingly, while scanning the frequencies of light from the first light source 1 and light from the second light source 2, a wavelength at each time can be ensured.

The non-polarization beam splitter 20 merges the beam L1 and beam L2 guided to the interferometer unit 400. The beam L1 entering the interferometer unit 400 is split by the non-polarization beam splitter 23 into the first reference beam which enters a reference surface 4 and the first object beam which enters a test surface 5. The first reference beam is reflected by the reference surface 4, and returns to the non-polarization beam splitter 23. The first object beam is reflected by the test surface 5, and returns to the non-polarization beam splitter 23. Similarly, the beam L2 entering the interferometer unit 400 is split by the non-polarization beam splitter 23 into the second reference beam which enters the reference surface 4 and the second object beam which enters the test surface 5. The second reference beam is reflected by the reference surface 4, and returns to the non-polarization beam splitter 23. The second object beam is reflected by the test surface 5, and returns to the non-polarization beam splitter 23. In this way, the non-polarization beam splitter 23 functions as a splitting element which splits beam from the first light source 1 into the first beam and second beam, splits beam from the second light source 2 into the third beam and fourth beam, guides the first beam and third beam to enter the reference surface 4, and guides the second beam and fourth beam to enter the test surface 5.

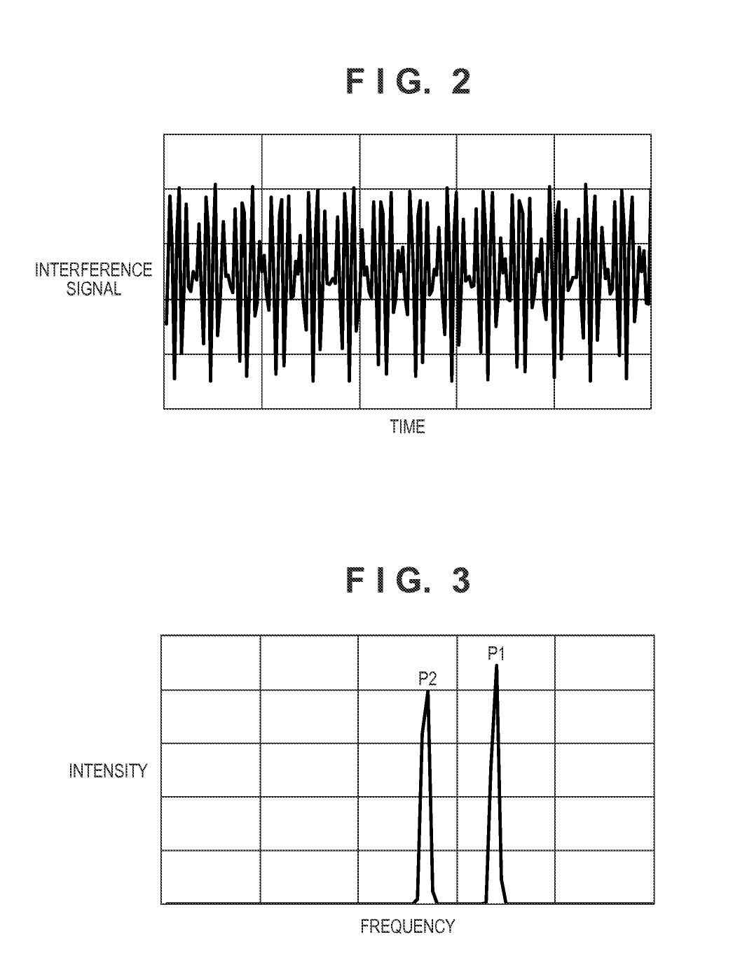

The first reference beam and first object beam, and the second reference beam and second object beam are merged by the non-polarization beam splitter 23, respectively, and enter the detector 6. The detector 6 detects beam containing the first interference beam formed by interference of the first reference beam and first object beam, and the second interference beam formed by interference of the second reference beam and second object beam (detects the first interference beam and second interference beam at once), and outputs (obtains) an interference signal S12 as shown in FIG. 2. The interference signal S12 is a signal obtained by adding an interference signal (first signal) S1 (corresponding to the first interference beam) generated by beam from the first light source 1, and an interference signal (second signal) S2 (corresponding to the second interference beam) generated by beam from the second light source 2. The interference signals S1, S2, and S12 are given by equations (1), (2), and (3), respectively:

$$\begin{matrix}S 1 ( t ) = {A}_{1}^{2} + {B}_{1}^{2} + {A}_{1} {B}_{1} cos ( \frac{4 π {Lf}_{1} ( t )}{c} ) & ( 1 ) \\ S 2 ( t ) = {A}_{2}^{2} + {B}_{2}^{2} + {A}_{2} {B}_{2} cos ( \frac{4 π {Lf}_{2} ( t )}{c} ) & ( 2 ) \\ S 12 ( t ) = S 1 ( t ) + S 2 ( t ) & ( 3 )\end{matrix}$$

where A₁ is the amplitude of the first reference beam, A₂ is the amplitude of the second reference beam, B₁ is the amplitude of the first object beam, and B₂ is the amplitude of the second object beam. f₁(t) is the frequency of light from the first light source 1 at time t, f₂(t) is the frequency of light from the second light source 2 at time t, and L is the distance between the reference surface 4 and the test surface 5. Note that the refractive index of the space is 1, and there is no dispersion.

Here, detecting the first interference beam and the second interference beam at once by the detector 6 may include detecting that with which each interference beam has completely overlapped and detecting that with which each interference beam has partially overlapped. By detecting the overlapped interference beams, the distance between the reference surface and the test surface is obtained by using the plurality of interfere beams detected at once.

In the embodiment, VCSEL (Vertical Cavity Surface Emitting Laser) are used as the first light source 1 and second light source 2. The center frequency fc₁ of light from the first light source 1 and the center frequency fc₂ of light from the second light source 2 are fc₁=448 [THz] and fc₂=353 [THz], respectively.

When obtaining the distance between the reference surface 4 and the test surface 5, the processing unit 13 controls the first light source 1 and second light source 2. The processing unit 13 controls the first light source 1 to scan the frequency of light from the first light source 1 in the first direction at the first scanning speed. Also, the processing unit 13 controls the second light source 2 to scan the frequency of light from the second light source 2 in the second direction opposite to the first direction at the second scanning speed different from the first scanning speed. In other words, the processing unit 13 controls the first light source 1 and second light source 2 so that the directions in which the frequencies of light from the first light source 1 and light from the second light source 2 are scanned become different from each other, and the absolute values of the scanning speeds of the frequencies become different from each other. In the embodiment, the processing unit 13 controls the first light source 1 to scan the frequency of light from the first light source 1 at a scanning speed fν₁=100 [GHz/sec] (forward direction). The processing unit 13 controls the second light source 2 to scan the frequency of light from the second light source 2 at a scanning speed fν₂=−79 [GHz/sec] (backward direction). When the measurement apparatus includes n (n=an integer of 3 or more) light sources capable of scanning the frequency, the processing unit 13 controls even the third light source different from the first and second light sources. More specifically, the processing unit 13 scans the frequency of light from the third light source at the third scanning speed different from the first and second scanning speeds in the first or second direction.

The processing unit 13 desirably controls n light sources to satisfy equation (4) for n (n=integer of 2 or more) light sources of the measurement apparatus MAA:

$${\sum }^{ } \frac{{fc}_{i}}{{fv}_{i}} = 0 \qquad ( 4 )$$

where fcᵢ (i=an integer of 1 to n) is the center frequency of light from each of the n light sources, and fνᵢ (i=an integer of 1 to n) is the scanning speed of the frequency of light from each of the n light sources.

In the embodiment, the first light source 1 and second light source 2 are controlled so that the absolute values of the scanning speeds of the frequencies of light from the first light source 1 and light from the second light source 2 become different from each other. By performing frequency analysis (for example, Fourier transform) for the interference signal S12 (see FIG. 2) output from the detector 6, the peak frequency P1 of the interference signal S1 and the peak frequency P2 of the interference signal S2 can be separated, as shown in FIG. 3. Note that the difference (speed difference) between the absolute values of the scanning speeds of the frequencies of light from the first light source 1 and light from the second light source 2 needs to be a speed difference capable of separating the peak frequencies P1 and P2. For example, the difference (frequency difference) between the peak frequencies P1 and P2 is set to be larger than the half frequency width.

In the embodiment, the first light source 1 and second light source 2 are controlled to satisfy equation (4). When the optical path length between the reference surface 4 and the test surface 5 does not change while scanning the frequencies of light from the first light source 1 and light from the second light source 2, the phase φ of the interference signal can be given by equation (5), as is apparent from equation (1):

$$φ ( t ) = \frac{4 π Lf ( t )}{c} \qquad ( 5 )$$

Temporal differentiation of the phase φ of the interference signal yields the frequency ν of the interference signal. The frequency ν of the interference signal can be given by equation (6):

$$v = \frac{d φ ( t )}{d t} = \frac{4 π {Lf}_{v}}{c} \qquad ( 6 )$$

where f_{ν} is the scanning speed of the frequency. As represented by equation (6), the frequency ν of the interference signal depends on only the distance L between the reference surface 4 and the test surface 5. By performing frequency analysis (for example, Fourier transform) for an interference signal output from the detector 6, the distance L between the reference surface 4 and the test surface 5 can be calculated from equation (7):

$$L = \frac{c}{4 π {f}_{v}} v \qquad ( 7 )$$

To the contrary, when the optical path length between the reference surface 4 and the test surface 5 changes while scanning the frequencies of light from the first light source 1 and light from the second light source 2, the phase φ′ of the interference signal is given not by equation (7), but by equation (8):

$${φ}^{′} ( t ) = \frac{4 π ( L + {L}_{v} \cdot t ) f ( t )}{c} \qquad ( 8 )$$

In this case, a change of the optical path length between the reference surface 4 and the test surface 5 is regarded as a linear change in one direction, and L_{ν} is the speed of the change.

As described above, temporal differentiation of the phase φ′ of the interference signal yields the frequency ν′ of the interference signal. The frequency ν′ of the interference signal can be given by equation (9):

$${v}^{′} \approx v + \frac{4 π {L}_{v} {f}_{c}}{c} \qquad ( 9 )$$

where f_{c} is the center frequency of light from the light source.

Thus, when the optical path length between the reference surface 4 and the test surface 5 changes while scanning the frequencies of light from the first light source 1 and light from the second light source 2, the distance L′ between the reference surface 4 and the test surface 5 is given by equation (10):

$${L}^{′} = L + \frac{{f}_{c}}{{f}_{v}} {L}_{v} \qquad ( 10 )$$

As represented by equation (10), when the optical path length between the reference surface 4 and the test surface 5 changes while scanning the frequencies of light from the first light source 1 and light from the second light source 2, a measurement error is generated by the product obtained by multiplying the change speed L_{ν} of the optical path length by f_{c}/f_{ν}. However, when the measurement apparatus uses n light sources, if the center frequency fcᵢ of light from each light source and the scanning speed fνᵢ of the frequency satisfy equation (4), a measurement error arising from a change of the optical path length can be reduced (removed) by averaging measurement values obtained from the respective light sources.

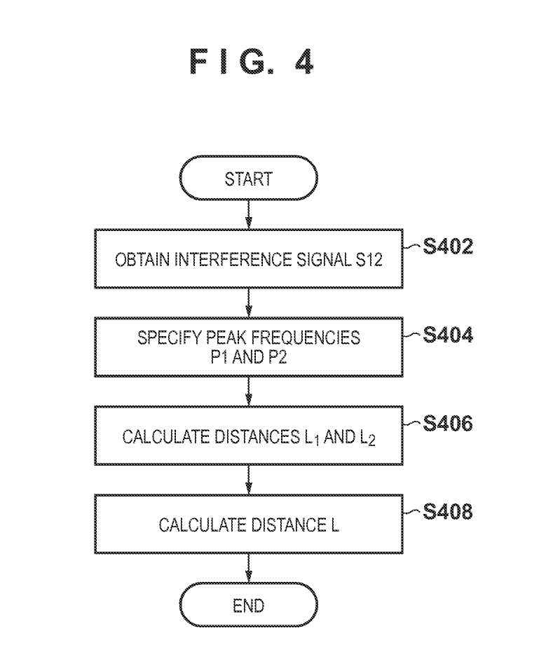

Processing of measuring the distance between the reference surface 4 and the test surface 5 in the measurement apparatus MAA will be explained with reference to FIG. 4. This processing is executed by executively controlling the respective units of the measurement apparatus MAA by the processing unit 13. The processing unit 13 includes a CPU and memory for controlling the overall arrangement (operation) of the measurement apparatus MAA.

In step S402, the processing unit 13 obtains the interference signal S12 (see FIG. 2) serving as a signal obtained by adding the interference signal S1 generated by beam from the first light source 1, and the interference signal S2 generated by beam from the second light source 2. More specifically, the processing unit 13 controls the first light source 1 and second light source 2 to scan the frequencies of light from the first light source 1 and light from the second light source 2 at the scanning speeds fν₁=100 [GHz/sec] and fν₂=−79 [GHz/sec]. While scanning the frequencies of light from the first light source 1 and light from the second light source 2, the processing unit 13 controls the detector 6 to detect beam containing the first interference beam and second interference beam, obtaining the interference signal S12.

In step S404, the processing unit 13 specifies the peak frequency P1 of the interference signal S1 and the peak frequency P2 of the interference signal S2. More specifically, the processing unit 13 performs Fourier transform for the interference signal S12 obtained in step S402 to separate it into the interference signals S1 and S2. Then, the processing unit 13 specifies the peak frequencies P1 and P2 of the interference signals S1 and S2 (see FIG. 3).

In step S406, the processing unit 13 calculates the distance L₁ between the reference surface 4 and the test surface 5 that corresponds to the interference signal S1, and the distance L₂ between the reference surface 4 and the test surface 5 that corresponds to the interference signal S2. More specifically, the processing unit 13 calculates the distance L₁ corresponding to the interference signal S1 and the distance L₂ corresponding to the interference signal S2 in accordance with equation (7) based on the peak frequencies P1 and P2 specified in step S404.

In step S408, the processing unit 13 calculates the distance L between the reference surface 4 and the test surface 5, based on the distances L₁ and L₂ calculated in step S406. More specifically, the processing unit 13 calculates, as the distance L between the reference surface 4 and the test surface 5, a distance obtained by averaging the distance L₁ corresponding to the interference signal S1 and the distance L₂ corresponding to the interference signal S2.

In this manner, even when the optical path length between the reference surface and the test surface changes while scanning the frequency of light from each light source, the measurement apparatus MAA can reduce a measurement error arising from the change of the optical path length, and measure the distance between the reference surface and the test surface at high precision. The measurement apparatus MAA requires neither a plurality of detectors for obtaining interference signals corresponding to respective light sources, nor a chopper for temporally switching an interference signal to be obtained by a detector. Therefore, the measurement apparatus MAA can suppress an increase in apparatus cost.

In the first embodiment, the measurement apparatus MAA measures the distance between the reference surface 4 and the test surface 5. However, the measurement apparatus MAA can also measure the shape of the test surface 5. In this case, the detector 6 is configured to include a plurality of detection regions where beam containing the first interference beam and second interference beam is detected at respective positions on the test surface 5. The processing unit 13 obtains distances between the reference surface 4 and the test surface 5 at respective positions based on interference signals output from the respective detection regions. As a result, the processing unit 13 can obtain the shape of the test surface 5. When the detector 6 cannot be configured to include a plurality of detection regions, the shape of the test surface 5 can be obtained by changing the positional relationship between the test surface 5 and the detector 6, and obtaining distances between the reference surface 4 and the test surface 5 for respective position relationships.

### Second Embodiment

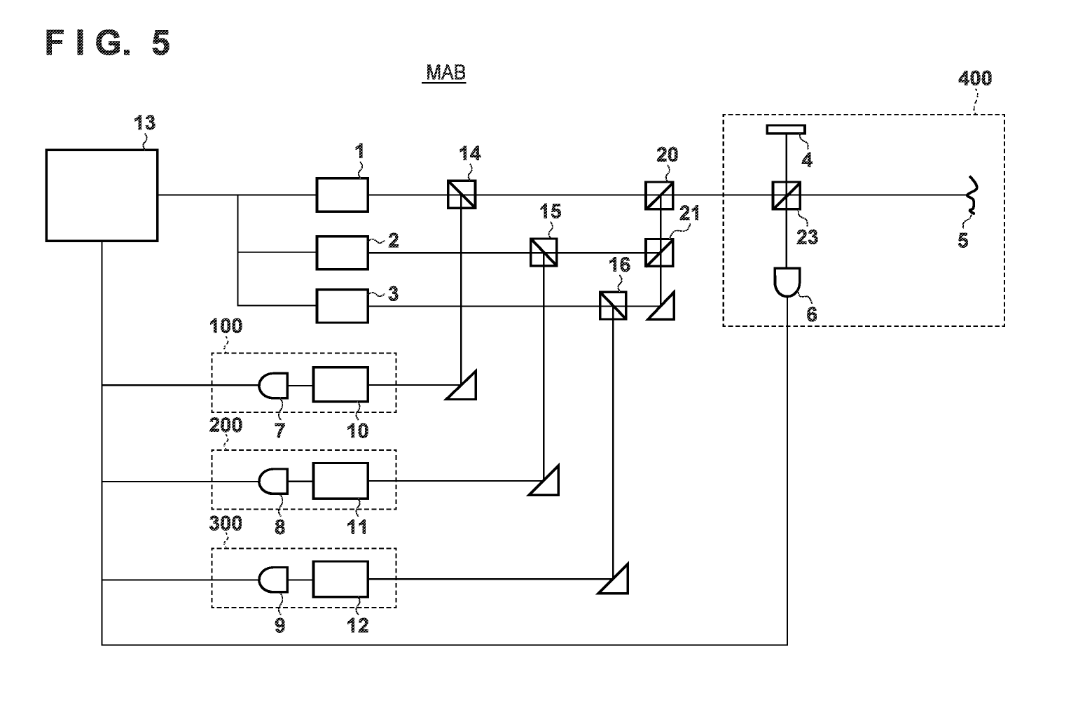

FIG. 5 is a view showing the arrangement of a measurement apparatus MAB in the second embodiment of the present invention. The measurement apparatus MAB is an interferometer which measures the distance between a reference surface and a test surface. In addition to the arrangement of the measurement apparatus MAA, the measurement apparatus MAB further includes a third light source 3, non-polarization beam splitters 16 and 21, and a wavelength measurement unit 300. The wavelength measurement unit 300 includes a Fabry-Perot etalon 12 and detector 9.

In the embodiment, the measurement apparatus MAB includes three light sources (a first light source 1, a second light source 2, and the third light source 3) capable of scanning the frequency of emitted light, but is not limited to this. For example, the number of light sources may be increased or decreased in accordance with a precision requested of measurement of the distance between a reference surface 4 and a test surface 5.

Beam L3 emitted by the third light source 3 is split into two by the non-polarization beam splitter 16. One beam is guided to the wavelength measurement unit 300, and the other beam is guided to an interferometer unit 400.

The beam L3 entering the wavelength measurement unit 300 passes through the Fabry-Perot etalon 12 serving as a wavelength reference element, and enters the detector 9. A processing unit 13 controls the frequency (wavelength) of light emitted by the third light source 3 based on a light intensity (intensity of the beam L3) detected by the detector 9. Note that the arrangement of the Fabry-Perot etalon 12 is the same as those of Fabry-Perot etalons 10 and 11, and a detailed description thereof will not be repeated.

A non-polarization beam splitter 20 and the non-polarization beam splitter 21 merge beam L1, beam L2, and beam L3 guided to the interferometer unit 400. The beam L3 entering the interferometer unit 400 is split by a non-polarization beam splitter 23 into the third reference beam which enters the reference surface 4 and the third object beam which enters the test surface 5. The third reference beam is reflected by the reference surface 4, and returns to the non-polarization beam splitter 23. The third object beam is reflected by the test surface 5, and returns to the non-polarization beam splitter 23.

The first reference beam and first object beam, the second reference beam and second object beam, and the third reference beam and third object beam are merged by the non-polarization beam splitter 23, respectively, and enter a detector 6. The detector 6 detects beam containing the first interference beam of the first reference beam and first object beam, the second interference beam of the second reference beam and second object beam, and the third interference beam of the third reference beam and third object beam (detects the first interference beam, second interference beam, and third interference beam at once), and outputs an interference signal 5123. The interference signal 5123 is a signal obtained by adding an interference signal S1 (corresponding to the first interference beam) generated by beam from the first light source 1, an interference signal S2 (corresponding to the second interference beam) generated by beam from the second light source 2, and an interference signal S3 (corresponding to the third interference beam) generated by beam from the third light source 3.

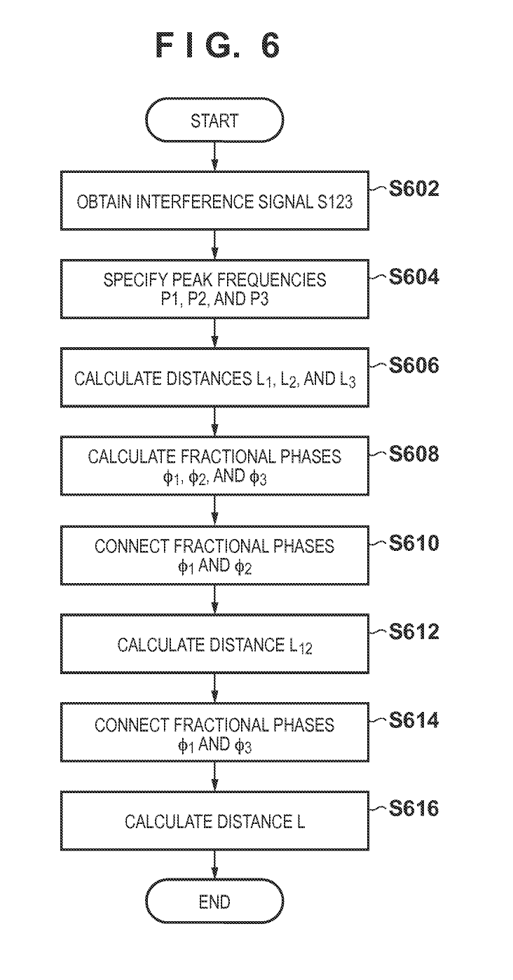

Processing of measuring the distance between the reference surface 4 and the test surface 5 in the measurement apparatus MAB will be explained with reference to FIG. 6. This processing is executed by executively controlling the respective units of the measurement apparatus MAB by the processing unit 13.

In step S602, the processing unit 13 obtains the interference signal S123 serving as a signal obtained by adding the interference signal S1 generated by beam from the first light source 1, the interference signal S2 generated by beam from the second light source 2, and the interference signal S3 generated by beam from the third light source 3. At this time, the processing unit 13 controls the first light source 1, second light source 2, and third light source 3 to satisfy equation (4). More specifically, in the embodiment, the frequencies of light from the first light source 1, light from the second light source 2, and light from the third light source 3 are scanned at the scanning speeds fν₁=100 [GHz/sec] (forward direction), fν₂=80 [GHz/sec] (forward direction), and fν₂=−49 [GHz/sec] (backward direction). The center frequency fc₁ of light from the first light source 1, the center frequency fc₂ of light from the second light source 2, and the center frequency fc₃ of light from the third light source 3 are fc₁=380 [THz], fc₂=382 [THz], and fc₃=420 [THz], respectively. In the embodiment, the measurement time is 1 sec. The frequency scanning amounts Δf₁, Δf₂, and Δf₃ of the first, second, and third light sources 1, 2, and 3 are Δf₁=100 [GHz], Δf₂=80 [GHz], and Δf₃=−49 [GHz], respectively.

In step S604, the processing unit 13 specifies the peak frequency P1 of the interference signal S1, the peak frequency P2 of the interference signal S2, and the peak frequency P3 of the interference signal S3. More specifically, the processing unit 13 performs Fourier transform for the interference signal S123 obtained in step S602 to separate it into the interference signals S1, S2, and S3. Then, the processing unit 13 specifies the peak frequencies P1, P2, and P3 of the interference signals S1, S2, and S3.

In step S606, the processing unit 13 calculates the distance L₁ between the reference surface 4 and the test surface 5 that corresponds to the interference signal S1, the distance L₂ between the reference surface 4 and the test surface 5 that corresponds to the interference signal S2, and the distance L₃ between the reference surface 4 and the test surface 5 that corresponds to the interference signal S3. More specifically, the processing unit 13 calculates the distance L₁ corresponding to the interference signal S1, the distance L₂ corresponding to the interference signal S2, and the distance L₃ corresponding to the interference signal S3 in accordance with equation (7) based on the peak frequencies P1, P2, and P3 specified in step S604.

In step S608, the processing unit 13 calculates fractional phases φ1, φ2, and φ3 at the center frequencies fc₁, fc₂, and fc₃ of the first, second, and third light sources 1, 2, and 3 based on the distances L₁, L₂, and L₃ calculated in step S606. More specifically, the processing unit 13 calculates the fractional phase φ using discrete Fourier transform (DFT), as represented by equation (11):

$${φ}_{i} = {tan}^{- 1} \frac{{\sum }_{j}^{ } {S}_{i} ( j ) sin \{ \frac{4 π {L}_{i}}{c} ( j - {fc}_{i} ) \}}{{\sum }_{j}^{ } {S}_{i} ( j ) cos \{ \frac{4 π {L}_{i}}{c} ( j - {fc}_{i} ) \}} ( i = 1 to 3 ) \qquad ( 11 )$$

Note that the fractional phase φ is calculated from equation (11) only within the range of ±π, and the interference order is unknown.

In step S610, the processing unit 13 connects the fractional phases φ₁ and φ₂ based on the average value Lₐᵥₑ of the distances L₁, L₂, and L₃ calculated in step S606 (phase connection). More specifically, the processing unit 13 calculates the interference order difference M₁₂ between the interference signal S1 at the center frequency fc₁ of the first light source 1 and the interference signal S2 at the center frequency fc₂ of the second light source 2 in accordance with equation (12):

$${M}_{12} = round \{ \frac{\frac{4 π {L}_{ave} ( {fc}_{2} - {fc}_{1} )}{c} - ( {φ}_{2} - {φ}_{1} )}{2 π} \} \qquad ( 12 )$$

where round( ) is a function of rounding an argument to an integer. Since Lₐᵥₑ is the average value of the distances L₁, L₂, and L₃, a measurement error arising from a change of the optical path length between the reference surface 4 and the test surface 5 is reduced (removed). Therefore, even when the optical path length between the reference surface 4 and the surface 5 to be measured changes while scanning the frequencies of light from the first light source 1, light from the second light source 2, and light from the third light source 3, the interference order difference M₁₂ can be calculated at high precision.

In step S612, the processing unit 13 calculates the distance L₁₂ between the reference surface 4 and the test surface 5 that corresponds to (an interference signal obtained from) the synthetic wavelength of light from the first light source 1 and light from the second light source 2. More specifically, the processing unit 13 calculates the distance L₁₂ from equation (13) using the center frequencies fc₁ and fc₂, the fractional phases φ₁ and φ₂, and the interference order difference M₁₂:

$${L}_{12} = \frac{c}{4 π} \cdot \frac{2 π {M}_{12} + {φ}_{2} - {φ}_{1}}{{fc}_{2} - {fc}_{1}} \qquad ( 13 )$$

The distance L₁₂ corresponds to the result of measurement at a frequency scanning amount corresponding to the frequency difference between the center frequency fc₁ of the first light source 1 and the center frequency fc₂ of the second light source 2. The distance L₁₂ improves to a precision of 1/20 (=Δf₁/(fc₂−fc₁)), compared to the distance L.

In step S614, the processing unit 13 connects the fractional phases φ₁ and φ₃ based on the distance L₁₂ calculated in step S612 (phase connection). More specifically, the processing unit 13 calculates the interference order difference M₁₃ between the interference signal S1 at the center frequency fc₁ of the first light source 1 and the interference signal S3 at the center frequency fc₃ of the third light source 3 in accordance with equation (14):

$${M}_{13} = round \{ \frac{\frac{4 π {L}_{12} ( {fc}_{3} - {fc}_{1} )}{c} - ( {φ}_{3} - {φ}_{1} )}{2 π} \} \qquad ( 14 )$$

In step S616, the processing unit 13 calculates the distance L between the reference surface 4 and the test surface 5. The processing unit 13 calculates, as the distance L, the distance L₁₃ between the reference surface 4 and the test surface 5 that corresponds to (an interference signal obtained from) the synthetic wavelength of light from the first light source 1 and light from the third light source 3. More specifically, the processing unit 13 calculates the distance L₁₃ from equation (15) using the center frequencies fc₁ and fc₃, the fractional phases φ₁ and φ₃, and the interference order difference M₁₃:

$${L}_{13} = \frac{c}{4 π} \cdot \frac{2 π {M}_{13} + {φ}_{3} - {φ}_{1}}{{fc}_{3} - {fc}_{1}} \qquad ( 15 )$$

The distance L₁₃ corresponds to the result of measurement at a frequency scanning amount corresponding to the frequency difference between the center frequency fc₁ of the first light source 1 and the center frequency fc₃ of the third light source 3. The distance L₁₃ improves to a precision of 1/400 (=(fc₂−fc₁)/(fc₃−fc₁)), compared to the distance L₁.

In this fashion, even when the optical path length between the reference surface and the test surface changes while scanning the frequency of light from each light source, the measurement apparatus MAB can reduce a measurement error arising from the change of the optical path length, and obtain an interference order difference at high precision. By using the interference order difference, the measurement apparatus MAB can measure the distance between the reference surface and the test surface at high precision. The measurement apparatus MAB requires neither a plurality of detectors for obtaining interference signals corresponding to respective light sources, nor a chopper for temporally switching an interference signal to be obtained by a detector. The measurement apparatus MAB can suppress an increase in apparatus cost. Similar to the measurement apparatus MAA, the measurement apparatus MAB can measure not only the distance between the reference surface and the test surface, but also the shape of the test surface.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-240660 filed on Nov. 1, 2011, which is hereby incorporated by reference herein in its entirety.

What is claimed is:

1. A measurement apparatus which measures a distance between a reference surface and a test surface, comprising:
n (n=an integer of not smaller than 2) frequency scanning light sources;
a splitting element configured to split beam from each of the n frequency scanning light sources to enter the reference surface and the test surface;
a detector configured to detect n interference beams at once, formed by interference of beam reflected by the reference surface and beam reflected by the test surface, and output an interference signal; and
a processing unit configured to perform processing of obtaining the distance,
wherein the processing unit controls to scan a frequency of light from a first light source out of the n frequency scanning light sources in a first direction at a first scanning speed, and controls to scan a frequency of light from a second light source different from the first light source, out of the n frequency scanning light sources, in a second direction opposite to the first direction at a second scanning speed different from the first scanning speed, and
the processing unit obtains the distance by separating the interference signal including detection results of the n interference beams, output from the detector, into n signals corresponding to the n interference signals and processing the n signals while controlling the n frequency scanning light sources.

2. The apparatus according to claim 1, wherein
the measurement apparatus comprises n (n=an integer of not smaller than 3) frequency scanning light sources, and
the processing unit controls to scan a frequency of light from a third light source different from the first light source and the second light source in one of the first direction and the second direction at a third scanning speed different from the first scanning speed and the second scanning speed.

3. The apparatus according to claim 1, wherein
the processing unit performs frequency analysis for the interference signal output from the detector to separate the interference signal into the n signals corresponding to the n interference beams, and
the processing unit obtains, as the distance, a distance obtained by averaging distances between the reference surface and the test surface that are calculated from n peak frequencies corresponding to the n signals obtained by the frequency analysis.

4. The apparatus according to claim 1, wherein letting fcᵢ (i=an integer of 1 to n) is a center frequency of light from each of the n frequency scanning light sources, and fνᵢ (i=an integer of 1 to n) is a scanning speed of a frequency of light from each of the n frequency scanning light sources,
the processing unit controls the n frequency scanning light sources to satisfy
$${\sum }^{ } \frac{{fc}_{i}}{{fv}_{i}} = 0.$$

5. The apparatus according to claim 1, wherein
the detector includes a plurality of detection regions where beam containing n interference beams is detected at a plurality of positions on the test surface, and
the processing unit obtains a shape of the test surface by obtaining distances at the plurality of positions based on interference signals output from the respective detection regions.
